(19) United States
(12) Patent Application Publication
(10) Pub. No.: US 2025/0181701 A1
(43) Pub. Date: Jun. 5, 2025

(54) CONSORTIUM-BASED APPLICATION AUTHENTICATION

(71) Applicant: Kyndryl, Inc., New York, NY (US)

(72) Inventors: Sachio Iwamoto, Richmond Hill (CA); Nadeem Malik, Austin, TX (US); Balaji Narasimhan, Cedar Park, TX (US); Kishor Grandhe, RoundRock, TX (US); Cesar Augusto Rodriguez Bravo, Alajuela (CR); Rajeev Puri, Huntersville, NC (US)

(21) Appl. No.: 18/524,243

(22) Filed: Nov. 30, 2023

(51) Int. Cl. G06Q 20/36

(52) U.S. Cl. CPC G06F 21/45; G06F 21/33

(57) ABSTRACT

In an aspect of the disclosure, there is a computer-implemented method including: obtaining, by a computing device, a request from an endpoint device to access at least one system resource; obtaining, by the computing device, a digital certificate from a shared digital wallet; obtaining, by the computing device, a validation result associated with the digital certificate from a blockchain ledger network; determining, by the computing device, whether the validation result authorizes access to the at least one system resource by the endpoint device; and sending authorization to the endpoint to deny or permit the endpoint device access to the at least one system resource based on the validation result.

### BACKGROUND

Aspects of the present invention relate generally to an authentication system (infrastructure) and, more particularly, to a consortium-based infrastructure and platform for endpoint authentication using a decentralized and self-sovereign identity.

Endpoint code signing solutions are available to verify authenticity of files and applications at an endpoint, e.g., smart phones, servers and other computing devices. These solutions are provided by operating system distributors as part of their software development kits (SDK). These solutions are centralized-based solutions.

For example, known endpoint code signing solutions assure applications are from known sources and the codes have not been modified since they are signed by attaching digital signatures. As these solutions depend on the signing tools provided by technology companies authorization (permission) mechanism are not flexible. These solutions are also limited to rely only on a single point of authorization. Moreover, developers need to provide personal information (PI) for the technology vendors and license fees to sign and distribute the software can be expensive. In addition, the ability of censorship is owned by the vendors. The current software verification are also typically available for only major enterprises, as these solutions are not designed or available for smaller projects in open source communities.

### SUMMARY

In a first aspect of the invention, there is a computer-implemented method including: obtaining, by a computing device, a request from an endpoint device to access at least one system resource; obtaining, by the computing device, a digital certificate from a shared digital wallet; obtaining, by the computing device, a validation result associated with the digital certificate from a blockchain ledger network; determining, by the computing device, whether the validation result authorizes access to the at least one system resource by the endpoint device; and sending authorization to the endpoint to deny or permit the endpoint device access to the at least one system resource based on the validation result.

In another aspect of the invention, there is a computer program product including one or more computer readable storage media having program instructions collectively stored on the one or more computer readable storage media. The program instructions are executable to: obtain a device request to access at least one system resource; obtain verifiable credentials of the device requesting access to the at least one system resource from a shared digital wallet; validate the verifiable credentials with a blockchain ledger network; and permit the device access to the at least one system resource based on a successful validation result of the device.

In another aspect of the invention, there is system including a processor, a computer readable memory, one or more computer readable storage media, and program instructions collectively stored on the one or more computer readable storage media. The program instructions are executable to: bridge communication between at least one endpoint device and a blockchain ledger network, comprising: obtaining verifiable credentials of multiple devices from a shared digital wallet; receiving verification from the block chain ledger network that the verifiable credentials are valid and access to a system resource is authorized; and providing authorization to a device of the multiple device requesting the system resource access to the system resource.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a swim lane diagram of an exemplary method in accordance with aspects of the invention.

### DETAILED DESCRIPTION

Aspects of the present invention relate generally to an authentication system (infrastructure) and, more particularly, to a consortium-based infrastructure and platform for endpoint authentication using a decentralized and self-sovereign identity (SSI). In specific embodiments, a community or consortium driven solution verifies authenticity of authorized endpoint devices to execute executable files, scripts, applications, services, and/or software/hardware products in an autonomously and decentralized manner. For example, the systems and methods leverage blockchain technologies with a plurality of trusted application credential issuers to authorize access and execution of executable files, scripts, applications, services, and/or software/hardware products, etc., on any given system. In this way, the systems and methods described herein access to such products are system based (e.g., based on ownership, for example, of an endpoint device) and not user based. As used herein, ownership is not to be considered a limiting terminology as it may be defined, for example, as an actual owner of one or more endpoint devices, an administrator of one or more endpoint devices, a management team, a defined group, etc. Advantageously, the systems and methods (e.g., tools) described herein provide a technical solution to a technology based problem by replacing a traditional centralized validator with a community-based decentralized validation mechanism to enhance the validation and execution of executable files, scripts, or applications, etc. Additionally, the systems and methods enable a more controlled execution environment based on the policies associated with any given endpoint.

According to aspects of the invention, the community or consortium-based security model verifies authenticity of executable files, scripts, applications, services, and/or software/hardware products (hereinafter referred also as “system resource(s)”) at an endpoint using a decentralized and self-sovereign Identity (SSI). By utilizing blockchain-based technologies (e.g., a blockchain ledger network) in the community or consortium-based dynamic authorization security model, authorization, access and execution of the executable system resources without reliance on a single central governing authority or intermediary third-parties to gain access to the system resources. The authentication process may also utilize business-policy based access control (e.g., different policies and different rules for different organizations) in a dynamic and flexible manner. For example, in an embodiment, the business-policy based access control provided by an issuer of the digital certificate (e.g., by an application credential issuer) is authenticated utilizing a centralized unified security bridge that implements and utilizes the blockchain technologies.

In aspects, the centralized, unified security bridge spans between, e.g., the blockchain ledger network, endpoints (e.g., server, computing device, etc.) associated with a community, organization or other group, a verifying agent and issuers of the endpoint credentials. The endpoints may be servers, smartphones, workstations, tablets, or other devices, that provide access to different system resources for different communities that won the endpoints. The system resources may be, for example, any executable system resource, e.g., accounting programs, financial programs, XML files, HTML files, databases, etc., whether they be cloud-based applications or services or stored internally, etc. In this way, the systems and methods simplify and automate the authentication and authorization workflow on different endpoints utilizing a plurality of third-party credentials issued to plural endpoints, and which can be authenticated through a single, centralized security bridge.

By way of example, the community or consortium-based security model may, e.g., determine the required validators to execute a given software product (e.g., executable files, scripts, or applications, etc.) in a given endpoint (e.g., device); gather credentials from third party issuers to validate the execution of the software product on any given device; leverage a plurality of shared wallets associated with a plurality of endpoints to determine the execution permissions of the software product on the given device; create an abstraction layer that provides a unified interface bridging between different actors as described herein; and provide a blockchain-based self-sovereign Identity platform and multiple security protection services to simplify and automate the authentication and authorization of the workflow on the different endpoints.

In this way, the community or consortium-based security model provides many advantages including, amongst others:
(i) An authorization (permission) mechanism that is flexible, scalable and resilient. For example, taking advantage of all features that blockchain based SSI brings, it is now possible to provide a distributed, decentralized, and immutable system. In this way, the backend platform that supports the security model is scalable, reliable, and resilient;
(ii) Security and privacy are improved by allowing authenticity of the executable system resources to be verified by a community or consortium based trusted authority. For example, credentials are owned and controlled by a company or organization that owns the endpoints by capitalizing on zero-knowledge proof (ZKP) technology. Therefore, the platform is autonomous, and ownership of personal information (PI) data can be controlled to enhance security and privacy;
(iii) Censorship is no longer owned by any technology vendor, as the security model utilizes distributed blockchain technologies;
(iv) Any sized project, for example, in open source communities can utilize the model described herein;
(v) License fees are independent from monopolized intermediary third-parties, thus making the model more cost effective to the end users;
(vi) A feature rich dynamic access control list (ACL) is provided. For example, the systems and methods provide an autonomous and decentralized credentials model which makes possible a wide variety of access policies to protect resources at the endpoints. The policies can be dynamically controlled, in addition to enabling new business use cases; and
(vii) A unified and simplified model for authentication of executable system resources at the endpoint can now be utilized and implemented. For example, an abstraction layer (Unified Security Bridge) enables the same security model for multiple endpoint attack vectors.

It should be understood that, to the extent implementations of the invention collect, store, or employ personal information provided by, or obtained from, individuals such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (Saas): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

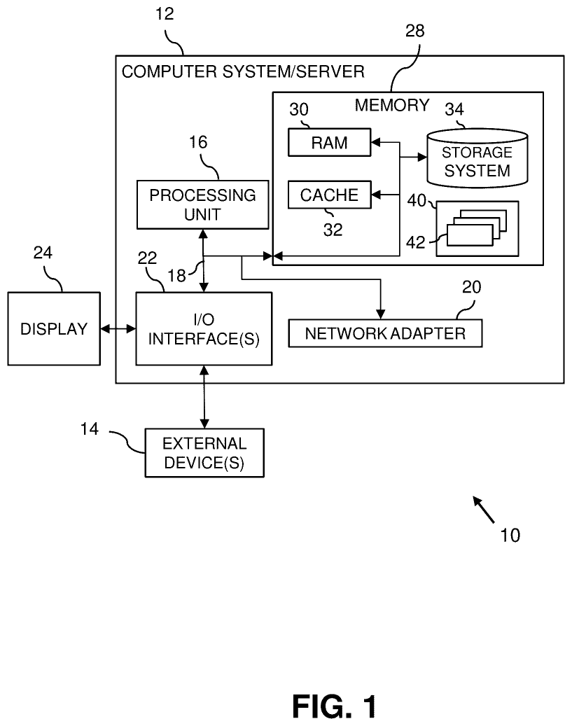

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

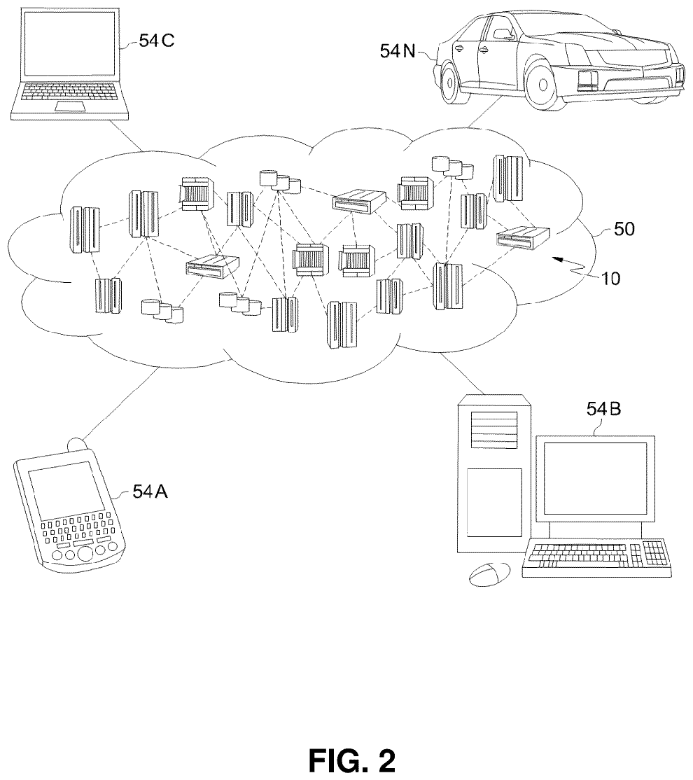

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

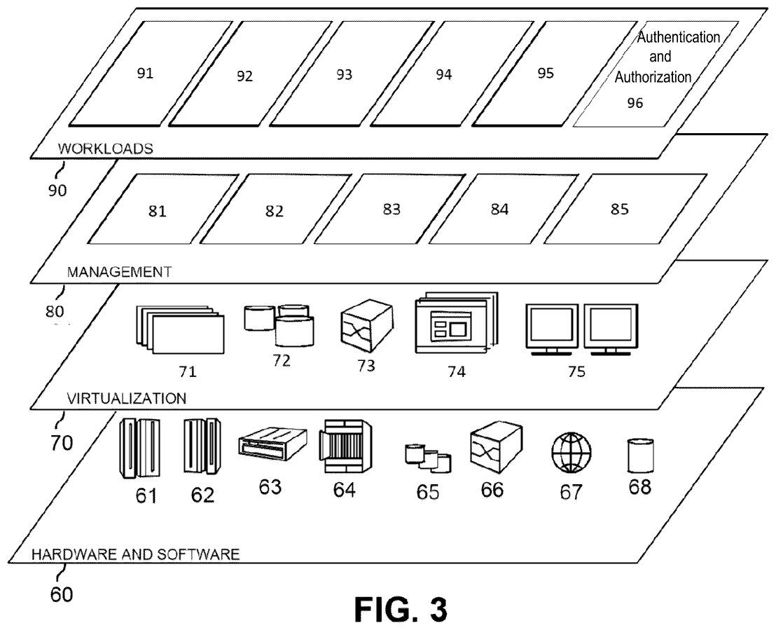

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and authentication and authorization 96.

Implementations of the invention may include a computer system/server 12 of FIG. 1 in which one or more of the program modules 42 are configured to perform (or cause the computer system/server 12 to perform) one of more functions of the authentication and authorization layer 96 of FIG. 3.

In more specific embodiments, the authentication and authorization layer 96 (implemented in the one or more of the program modules 42) provides a community or consortium-based security model to authenticate endpoints and authorize access and execution of executable system resources using a decentralized and self-sovereign identity (SSI) security model. The model provides an open ecosystem to authenticate the endpoints based a community approach, e.g., which endpoint belongs to or are owned by specific communities, e.g., different groups who own or administer the endpoints. The different groups may be different organizations or departments within a single company, amongst other examples. For the different departments may be a legal department, accounting department, IT department, and a human resources department, etc., each owning or administering their own endpoints and which should have access to only certain executable system resources.

Also, as should be understood by those of skill in the art, the open ecosystem will authorize access to system resources in a decentralized and autonomous manner based on digital certificates that are issued by the different departments or administrators, e.g., application credential issuers. In an aspect of the invention, the digital certificates include verifiable credentials which allow access to and execution of certain executable system resources by certain verifiable endpoints amongst a plurality of endpoints. As already noted herein, the community may be a specific organization, department within an organization or other defined group, which have endpoints which can only access certain executable system resources.

In more specific embodiments, the authentication and authorization layer 96 provides:
(i) endpoints with the ability to be authenticated without relying on a single central governing authority or intermediary third-parties;
(ii) a unified interface bridging between a blockchain-based platform and multiple endpoints to simplify and automate the authentication and authorization workflow on the endpoints;
(iii) a security model to allow multiple organizations to use the same model by registering their domain; and
(iv) shared digital wallets for each department within an organization for verifying each endpoint that is owned or administered by the department (e.g., there is no requirement to have individual digital wallets for each endpoint).

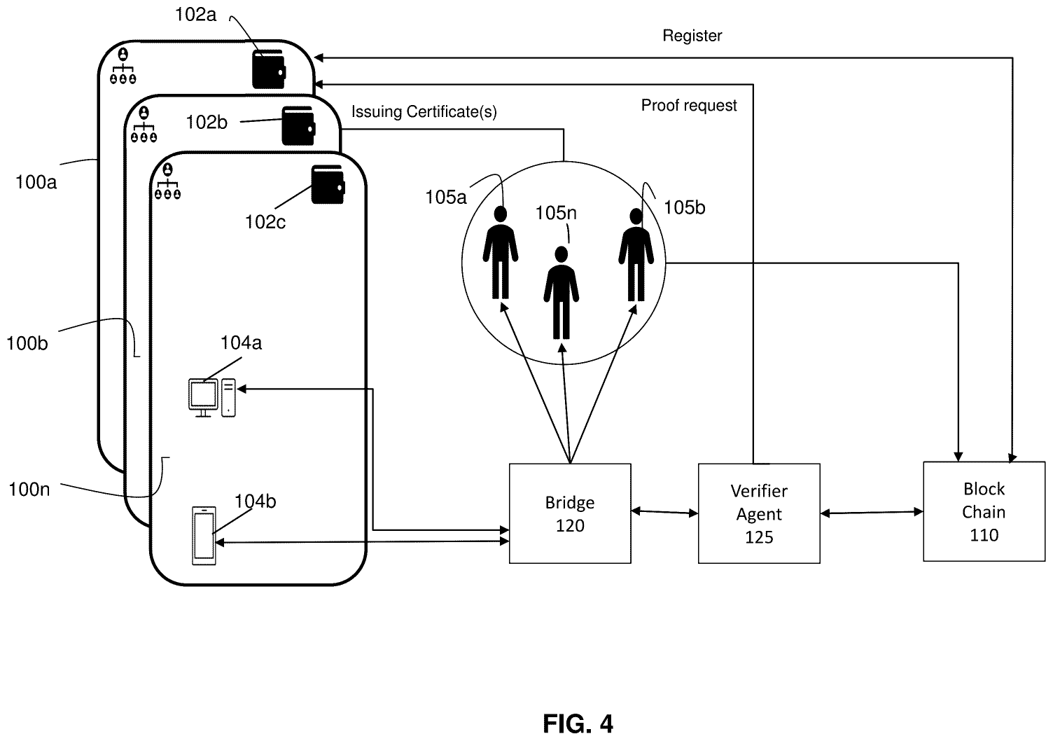

Also, and advantageously, the authentication and authorization layer 96 is scalable and resilient. For example, the authentication and authorization layer 96 takes advantage of all blockchain features including, for example, being distributed, decentralized, and immutable. Therefore, the backend platform (e.g., unified security bridge 120 of FIG. 4) to support the security model described herein is scalable, reliable, and resilient. Moreover, the authentication and authorization layer 96 improves security and privacy as it does not rely on passwords which have a risk of being exposed. The credentials are also owned and controlled by the organization (e.g., owner or administrator of the endpoints instead of being stored on servers that provide SSO solutions or directory services). Also, the backend platform (e.g., unified security bridge 120 of FIG. 4) is autonomous, with the specific organization, department within an organization or other defined group controlling the ownership of personal information and, hence, enhancing privacy.

In addition, the authentication and authorization layer 96 provides a feature rich dynamic access control list, which provides autonomous and decentralized credentials. This makes possible a wide variety of access policies to protect system resources at the endpoints. The policies, e.g., business rules, can be dynamically controlled and will enable new business use cases. Further, the authentication and authorization layer 96 provides unified and simplified authentication which enables the same security model for multiple endpoint attack vectors.

FIG. 4 shows a block diagram of an exemplary environment in accordance with aspects of the invention. In embodiments, the environment includes a plurality of different organizations, departments within an organization or other defined groups 100a, 100b . . . 100n, each of which has a shared digital wallet 102a, 102b . . . 102n for different endpoints 104a, 104b. In embodiments, the different organizations, departments within an organization or other defined groups 100a, 100b . . . 100n can have one or multiple a shared digital wallets.

The different organizations, departments within an organization or other defined groups 100a, 100b . . . 100n each own or administer a plurality of endpoints 104a, 104b (e.g., servers, workstations or other computing devices). The endpoints 104a, 104b will be authenticated and authorized to access and/or execute system resources (e.g., software products, databases, specific files or applications (e.g., local or web-based applications, etc.) based on verifiable credentials of digital certificates within the shared digital wallet 102a, 102b . . . 102n. In this implementation, each user of the endpoints may still provide a user ID and password prior to the endpoints being verified to access and/or execute the executable system resources.

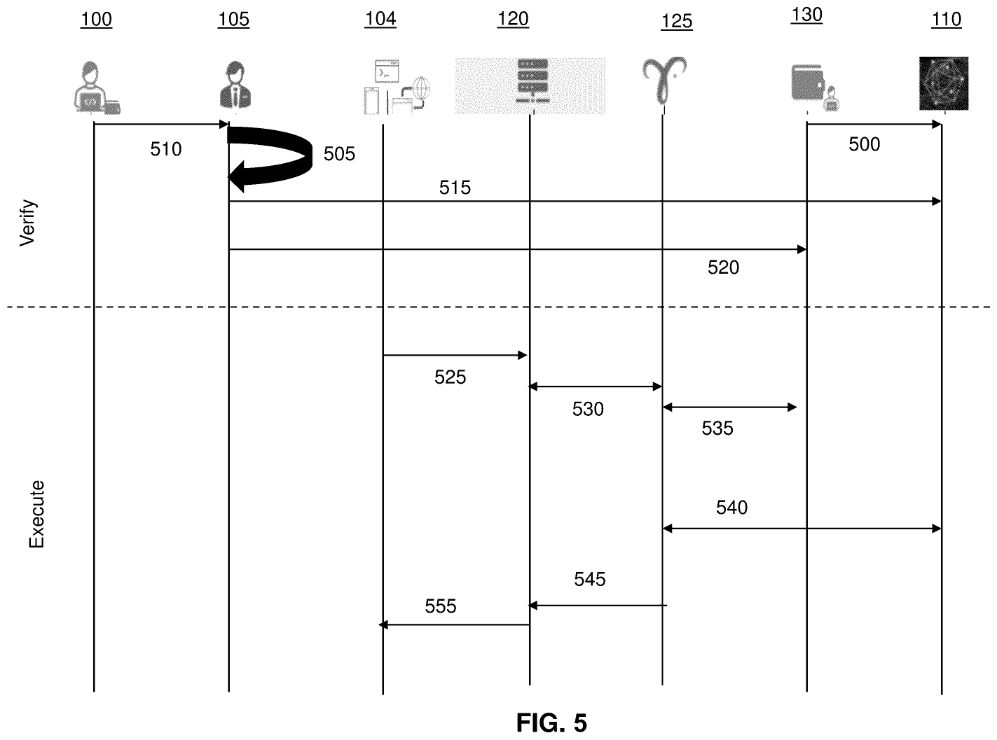

The digital certificates with verifiable credentials are issued by application credential issuers 105a, 105b . . . 105n. As should be understood by those of skill in the art, the digital certificates are 100% secure as everything in the digital wallet is trusted. The digital certificates (e.g., credentials) are stored in the cloud environment as shown in FIG. 2, for example, using a digital wallet and will be used at the time of authentication to verify with a blockchain ledger 110 as described herein. For example, the digital wallet is connected to the blockchain network via a holder agent (as described in FIG. 5) for the plurality of different specific organizations, departments within an organization or other defined groups 100a, 100b . . . 100n. An exemplary holder agent is a component of HyperLedger Aries toolkit. Hyperledger Aries toolkit or any holder agent toolkit contemplated herein is a complete toolkit for decentralized identity solutions and digital trust. The holder agent will issue, store and present verifiable credentials with maximum privacy preservation, and establish confidential, ongoing communication channels.

The digital certificates can be issued by a plurality of different application credential issuers 105a, 105b . . . 105n. The application credential issuers 105a, 105b . . . 105n are community or consortium-driven trusted authorities. In embodiments, the application credential issuers 105a, 105b . . . 105n may be different service providers, which issue digital certificates to authenticate a plurality of different endpoints 104a, 104b owned or administered by the specific organizations, departments within an organization or other defined groups 100a, 100b . . . 100n. The application credential issuers 105a, 105b . . . 105n may be administrators, e.g., IT or security professionals of the different organizations, departments within an organization or other defined groups 100a, 100b . . . 100n. The issued digital certificates will be used to verify the endpoints 104a, 104b so as to access and/or execute different system resources, e.g., executable system resources, managed by the application credential issuers 105a, 105b . . . 105n (and/or owned and/or administered by the different organizations, departments within an organization or other defined groups 100a, 100b . . . 100n).

In some examples, the application credential issuers 105a, 105b . . . 105n may be an application vendor, a security firm or specific organizations (companies). The system resources may be any software product such as an executable system resource, whether residing on the Internet or cloud based infrastructure as shown in FIG. 2, for example.

In further embodiments, the application credential issuers 105a, 105b . . . 105n are responsible for examining the authenticity of the endpoints 104a, 104b associated with a particular organization, department within an organization or other defined group 100a, 100b . . . 100n, upon request by the, e.g., wallet holders. Moreover, the application credential issuers 105a, 105b . . . 105n may set policies and/or rules which are provided within the digital certificates to allow the endpoints 104a, 104b to gain access and execute a particular executable system resources.

These policies and/or rules are, for example, “or” rules or “and/or” rules. By way of illustration, a rule may be an endpoint 104a, 104b needs to be associated with organization “X” or department “Y”. Another rule may be an endpoint 104a, 104b needs to be owned by organization “X” and be at a location “A” within a particular building. Of course, different policies and/or rules are also contemplated herein. In any of these scenarios, the application credential issuers 105a, 105b . . . 105n set the policies and/or rules, and determine whether the plurality of endpoints 104a, 104b associated with any of the different organizations 100a, 100b . . . 100n meet the criteria for any of the policies and/or rules, and issue one or more digital certificates with such qualifications for each of the plurality of different organizations 100a, 100b . . . 100n. Accordingly, the application credential issuers 105a, 105b . . . 105n will issue verifiable credentials, e.g., verifiable digital certificate, when they confirm that the endpoint satisfy certain criterion.

The plurality of different organizations, departments within an organization or other defined groups 100a, 100b . . . 100n register with a blockchain network 110. In embodiments, the registration may include registration of each of the endpoints 104a, 104b. The blockchain network 110 is a blockchain ledger network for self-sovereign (SSI). The blockchain ledger network for self-sovereign identity 110 is a purpose-built permissioned distributed blockchain ledger network for decentralized identity to support verifiable credentials based on zero-knowledge proof (ZKP) technology. It should be understood by those of skill in the art that the blockchain ledger network for self-sovereign identity 110 may be multiple nodes in the network, with each node having a copy of the entire ledger.

Still referring to FIG. 4, the environment also includes a unified security bridge 120 and a verifier agent 125. The unified security bridge 120 may be an abstraction layer as shown and described with respect to FIG. 3, and which implements the workload layer of authentication and authorization layer 96. More specifically, the unified security bridge 120 is a custom controller based on Hyperledger Aries where a set of common APIs is implemented to expand the capability of the self-sovereign identity.

The unified security bridge 120 bridges the communication between the endpoints 104a, 104b and the blockchain ledger network 110, as an abstraction layer. The unified security bridge 120 is scalable and can be used for authentication amongst any number of endpoints 104a, 104b, application credential issuers 105a, 105b . . . 105n and plurality of registered organizations 100a, 100b . . . 100n. Accordingly, the unified security bridge 120 is a unified interface bridging between a blockchain-based platform and multiple endpoints to simplify and automate the authentication and authorization workflow. For example, the unified security bridge 120 will receive a request for execution of the system resource and, upon checking with the verifier agent 125 and/or blockchain 110 will allow or deny access and/or execution of the system resource by the requesting endpoint 104a, 104b.

The unified security bridge 120 may also include business logic that realizes a Business-rules-based Access Control (B-RBAC) model. In this way, access (read, write, execute) authorization for each endpoint 104a, 10b4 may be programmatically implemented based on schema attribute values of more than one credential schemas from multiple application credential issuers 105a, 105b, . . . 105n. Accordingly, each endpoint 104a, 10b4 may include one or more credentials (digital certificate) from multiple issuers which, depending on the business rules, all or any combination of which need to be verified (authenticated) for access to a system resource by the each endpoint 104a, 10b4. Also, the unified security bridge 120 includes a database that stores the connection information between organizations (e.g., application credential issuers 105a, 105b . . . 105n) and holders of the digital wallet.

The verifier agent 125 is a component that enables peer-to-peer interactions between agents and/or the blockchain ledger network for self-sovereign identity 110. For example, the verifier agent 125 gathers the certificate from the certificate holder (e.g., holder agent), sends the certificate to the blockchain ledger network for self-sovereign identity 110, gathers the response and provides one or several responses to the unified security bridge 120. The unified security bridge 120 will, in turn, provide the authorization to access and/or execute a system resource at each endpoint 104a, 104b. The unified security bridge 120 will also deny access to a system resource should the digital certificates of the endpoint 104a, 104b not be verified on the blockchain ledger network for self-sovereign identity 110. In this way, the unified security bridge 120 gathers all responses and performs the validation. The unified security bridge 120 also stores and implements the business rules provided by the application credential issuers 105a, 105b . . . 105n, which are verified within the digital certificate through the use of the blockchain ledger network for self-sovereign identity 110.

In an embodiment, the verifier agent 125 is a component of, for example, HyperLedger Aries toolkit. For example, in an embodiment, the verifier agent 125 can be a toolkit, e.g., an API, to validate the assets, e.g., credentials, in the digital certificate. More specifically, the verifier agent 125 is a trusted agent which provides agent processes controlled by credential verifiers (e.g., application credential issuers 105a, 105b . . . 105n) to verify the authenticity of digital assets, e.g., system resources, through the blockchain network. For example, the verifier agent 125 requests digital certificates from the wallet holder to authenticate each endpoint 104a, 10b4 based on the credentials in the digital certificate. Also, in an embodiment, the verifier agent 125 can be middleware which accesses the blockchain ledger network for self-sovereign identity 110 to determine whether the credential in the digital certificate remains active, has been revoked or has been changed in some manner. Also, the verifier agent 125 has an inherent trust with the application credential issuers 105a, 105b . . . 105n.

In an example use case of FIG. 4 and which is further described with reference to FIG. 5, assume one of the endpoints 104a want to access a payroll system. The endpoint 104a will provide a request for access to the unified security bridge 120, which will be used to determine whether access to the payroll system is authorized or not. In this case, access can be granted when five certificates (e.g., verifiable credentials) for the endpoint 104 can be validated or verified. In this case, the verifier agent 125 will request all of the certificates from a shared wallet from, for example, organization 100a. The verifier agent 125 will obtain the certificates from the shared wallet, and will access the blockchain ledger network for self-sovereign identity 110 and ask for validation of the certificates. The blockchain ledger network for self-sovereign identity 110 will provide the results and the verifier agent 125 will report such results to the unified security bridge 120. In this example, if all the certificates are found to be valid, the unified security bridge 120 will provide the requesting endpoint authorization to access the payroll system.

FIG. 5 shows a swim lane diagram of an exemplary method in accordance with aspects of the present invention. Steps of the method may be carried out in the environment of FIG. 4 and are described with reference to elements depicted in FIG. 4. In embodiments, steps 500 to 520 are steps to verify the application and issue credentials; whereas steps 525 to 550 are steps to execute an application (e.g., authenticate the endpoint for access to a system resource). The steps of the swim lane diagram of FIG. 5 can be implemented with the following actors: a specific organization, department within an organization or other defined group 100, the application credential issuer 105, the endpoint 104, the unified security bridge 120, the verifier agent 125, a credential holder agent 130 and the blockchain ledger network for self-sovereign identity 110.

In embodiments, the credential holder agent 130 may be a shared wallet for a specific organization, department or group which own specific endpoints 104. For example, a legal department, an IT department, accounting department, etc., may each have their own shared wallet comprising digital credentials provided by different application credential issuer 105 to verify each of their own endpoints 104. This is distinguishable from each of the endpoints having their own individual wallet. In this way, different credentials for different endpoints can be stored in a central repository for a single organization, department or group.

At step 500, the system creates a shared wallet for each organization, department within an organization or other defined group (if it does not already exist). In accordance with aspects of the invention, only a single wallet needs to be created for each group, e.g., specific organization, department within an organization or other defined group 100. This step is required only once until the digital wallet is deleted. In embodiments, for example, the credential holder agent 130 may register with the blockchain ledger network for self-sovereign identity 110.

At step 505, the application credential issuer 105 will examine and certify executable system resource prior to issuing any credentials. The credentials can be one or more verifiable certificate.

At step 510, the wallet holders who own the endpoint 104, e.g., organization, department within an organization or other defined group 100, request a verifiable credentials for each of the executable system resources At step 515, the application credential issuer 105 may initiate the issuance of the credentials. For example, at step 515, the application credential issuer 105 verifies the wallet holder's ID (e.g., each endpoint 104) by connecting to the blockchain ledger network for self-sovereign identity 110. And at step 520, once the application credential issuer 105 confirms the authenticity of the digital wallet, the application credential issuer 105 will initiate the process of issuing credentials (including schema attributes) and sending the credentials to the digital wallet, e.g., credential holder agent 130.

At step 525, the execution of the executable system resources is initiated by and at the endpoint 104, i.e., where a user already logged into an endpoint 104 requests execution of an executable system resources. In this way, the processes described herein may be considered a secondary validation process, as the user ID and the password of the user accessing the endpoint has already been validated prior to requesting execution of a system resource. This may be performed by the users manually or automatically through system services. For example, a kernel of the endpoint operating system e.g., Linux, will notify a software framework that controls the application execution based on policies. In embodiments, it is contemplated that operating system distributions provide the software framework natively. For example, Linux provides fapolicyd daemon. The software framework service (daemon) sends attributes that are necessary to verify the authenticity of the executable system resources to the unified security bridge 120. By way of a non-limiting, illustrative example, the attributes may include file hash (md5sum, SHA256, etc.), name, size, etc.

At step 530, the unified security bridge 120 connects to the verifier agent 125. In this step, the unified security bridge 120 will try to obtain the verifiable credentials of the application from the shared wallet (credential holder agent 130) via verifier agent 125 based on the file attributes. For example, at step 535, the verifier agent 125 sends a proof request to the credential holder agent 130, and the credential holder agent 130 sends the credentials back to the verifier agent 125. At step 540, the verifier agent 125 verifies the wallet ID against the blockchain ledger network for self-sovereign identity 110 after it receives the credentials from the credential holder agent 130. For example, the verifier agent 125 sends a user ID verify key to the blockchain ledger network for self-sovereign identity 110 and the blockchain ledger network for self-sovereign identity 110 sends a user ID verification response back to the verifier agent 125.

At step 545, the verifier agent 125 sends a validation result to the blockchain ledger network for self-sovereign identity 110. This validation result may be, for example, approve access or deny access or change has occurred. At step 550, if verification is successful, the credential is valid and the schema attributes satisfy the defined policy, then a plug-in from the unified security bridge 120 sends the decision back to a kernel via the software framework service (e.g., the unified security bridge 120) to the endpoint 104, which allows the endpoint 104 to execute the system resources, e.g., executable system resource. If the credential is not valid, the login to the system resources, e.g., executable system resource, will be denied by the blockchain ledger network for self-sovereign identity 110. In this way, only endpoints 104 with valid credentials, e.g., a valid credential as a cybersecurity employee, can access and execute authorized system resources.

### Example Use Case:

In an example case, company “A” has several different departments “B”, “C”, and “D”. The departments have many different endpoints to access specific executable applications “X”, “Y” and “Z”. For example, department “B” should have access to executable application “X”, but not executable applications “Y” and “Z”. Similarly, department “C” should have access to executable application “Y”, but not executable applications “X” and “Z”, and department “D” should have access to executable application “Z”, but not executable applications “X” and “Y”. The endpoints for each of the different departments are issued a digital certificate with credentials registered in the blockchain ledger network for self-sovereign identity 110 and which can be held in the digital wallet of the company “A”. The digital certificate will include the identification information of each of the endpoints and which department owns or administers these endpoints.

As the credentials of a digital certificate cannot be forged and are trusted by the blockchain ledger network for self-sovereign identity 110 and verifier agent 125, upon logging into an endpoint for department “B”, the digital certificate can be verified and the endpoint can be authenticated for authorization to access the executable application “X” using the unified security bridge 120. For example, the unified security bridge 120 can provide authorization to an endpoint device allowing the endpoint device for the department “B” to access executable application “X”. If another endpoint in a different department “Y” or “Z” is requesting access to executable application “X”, the unified security bridge 120 can deny access. In this way, any endpoint owned by a specific department can gain access to only executable system resources in which that department has authorization to access. This can be done without a password or centralized authority.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
obtaining, by a computing device, a request from an endpoint device to access at least one system resource;
obtaining, by the computing device, a digital certificate from a shared digital wallet;
obtaining, by the computing device, a validation result associated with the digital certificate from a blockchain ledger network;
determining, by the computing device, whether the validation result authorizes access to the at least one system resource by the endpoint device; and
sending authorization to the endpoint to deny or permit the endpoint device access to the at least one system resource based on the validation result.

2. The method of claim 1, wherein the shared digital wallet is associated with multiple endpoints of a single owner.

3. The method of claim 1, wherein the digital certificate includes verifiable credentials of the endpoint device that requests access to the at least one system resource.

4. The method of claim 3, wherein the verifiable credentials of the endpoint device are sent from a verifier agent to a unified security bridge which sends the validation result to the endpoint device.

5. The method of claim 4, wherein the unified security bridge is scalable to multiple owners of different endpoint devices and multiple endpoints.

6. The method of claim 4, wherein the verifier agent verifies a wallet ID against the blockchain ledger network and sends the verification to the unified security bridge.

7. The method of claim 6, further comprising sending a user ID verify key to the blockchain ledger network and receiving a user ID verification response back to the verifier agent.

8. The method of claim 1, wherein the determining step comprises receiving the validation result from the blockchain ledger network and determining if verification is successful by determining a verifiable credential is valid and schema attributes satisfy a defined policy, and further comprising sending a decision back to the endpoint device to permit access to the at least one system resource when the verifiable credential is valid and schema attributes satisfy the defined policy.

9. The method of claim 8, wherein the validation result is sent through a unified security bridge that supports a scalable verification model shared amongst multiple endpoint devices each of which provide a request to the unified security bridge to access the system resource.

10. The method of claim 9, further comprising:
obtaining rules from the application credential issuers, and applying the rules to credentials associated with the verifiable credentials for the endpoint; and
applying the rules by the unified security bridge to the verifiable credentials to determine whether the endpoint is permitted access to the at least one system resource.

11. The method of claim 10, wherein the unified security bridge is scalable and communicates between the blockchain ledger network, a verifier agent and multiple endpoints.

12. The method of claim 1, wherein the computing device includes software provided as a service in a cloud environment.

13. A computer program product comprising one or more computer readable storage media having program instructions collectively stored on the one or more computer readable storage media, the program instructions executable to:
obtain a device request to access at least one system resource;
obtain verifiable credentials of the device requesting access to the at least one system resource from a shared digital wallet;
validate the verifiable credentials with a blockchain ledger network; and
permit the device access to the at least one system resource based on a successful validation result of the device.

14. The computer program product of claim 13, further comprising authenticating and authorizing the device to access the at least one system resource using a decentralized and self-sovereign identity (SSI) security model.

15. The computer program product of claim 14, wherein the decentralized and self-sovereign identity (SSI) security model comprises a unified interface bridging between a blockchain-based platform and multiple devices owned by or administered by different groups.

16. The computer program product of claim 13, wherein the shared digital wallet is shared amongst multiple devices owned by a same owner.

17. The computer program product of claim 13, wherein the validating of the verifiable credentials is through a unified security bridge that supports a scalable verification model shared amongst multiple owners of different devices which request access to at least one system resource.

18. A system comprising:
a processor, a computer readable memory, one or more computer readable storage media, and program instructions collectively stored on the one or more computer readable storage media, the program instructions executable to:
bridge communication between at least one endpoint device and a blockchain ledger network, comprising:
obtaining verifiable credentials of multiple devices from a shared digital wallet;
receiving verification from the block chain ledger network that the verifiable credentials are valid and access to a system resource is authorized; and
providing authorization to a device of the multiple device requesting the system resource access to the system resource.

19. The system of claim 18, wherein the verification includes applying rules against the verifiable credentials.

20. The system of claim 18, wherein the verification is provided to a verifying agent from the blockchain ledger network, upon a request, and the bridging is provided by a unified security bridge that support a scalable verification model shared amongst multiple providers, the verifiable credentials being in the shared digital wallet which is associated with an owner of multiple devices.
